(19) United States
(12) Patent Application Publication
(10) Pub. No.: US 2016/0242981 A1
(43) Pub. Date: Aug. 25, 2016

(54) DEVICE FOR SUPPORTING AND POSITIONING A PATIENT IN A MEDICAL EQUIPMENT

(71) Applicant: Ion Beam Applications, Louvain-la-Neuve (BE)

(72) Inventors: Alexandre DEBATTY, Hevillers (BE); David WIKLER, Waterloo (BE); Paul-François DOUBLIEZ, Auderghem (BE)

(73) Assignee: Ion Beam Applications

(21) Appl. No.: 15/051,625

(22) Filed: Feb. 23, 2016

(30) Foreign Application Priority Data
Feb. 24, 2015 (EP) 15156383.0
Feb. 24, 2015 (LU) 92662

(51) Int. Cl. A61G 13/04

(52) U.S. Cl. CPC A61G 13/04

(57) ABSTRACT

A device for supporting and positioning a patient in a medical equipment comprises a positioning mechanism supporting a patient support unit. The positioning mechanism comprises a motorized rotary joint member for positioning the patient support unit using a motorized pivoting motion about a pivot axis. A rotational release unit associated with the motorized rotary joint member comprises an override bearing arranged adjacent to or in the motorized rotary joint member configured to be substantially coaxial with the pivot axis, and allow a free pivoting motion of the positioning mechanism about the pivot axis. A rotation locking mechanism cooperates with the override bearing. This rotation locking mechanism switches between a locked state, in which it locks the override bearing in a mechanically defined angular position, and an unlocked state, in which the override bearing is unlocked and the positioning mechanism can freely pivot about the pivot axis.

### CROSS-REFERENCE TO RELATED APPLICATION

This application is based upon and claims the benefit of prior European Patent Application No. 15156383.0, filed on Feb. 24, 2015, and Luxembourg Patent Application No. 92662, filed on Feb. 24, 2015, the entire contents of which are incorporated herein by reference.

### TECHNICAL FIELD

The present disclosure relates to a device for positioning a patient in a medical equipment, in particular a radiation therapy equipment.

### BACKGROUND

A device for positioning a patient in a medical equipment is also called a “patient positioning system (PPS)”. In a radiation therapy equipment, the patient positioning system has to warrant a very precise positioning and orientation of the patient relative to the radiation therapy equipment. Therefore, a modern patient positioning system may include three degrees of freedom for positioning a patient support table in space (generally two degrees of freedom parallel to a horizontal plane, and one degree of freedom parallel to a vertical plane), and three further degrees of freedom for orientation of the patient support table in space (generally three rotational degrees of freedom allowing a back and forward tilting, a top rotation and a rolling movement of the patient support table). All these degrees of freedom are principally motorized using a drive unit with a very high reduction ratio to achieve a slow motorized motion (for safety reasons) and a very precise positioning.

In the final irradiation position, the patient to be irradiated is sandwiched between an irradiation nozzle and the patient support table supported by the patient positioning system. There are numerous situations in which it is required to bring the patient rapidly out of this “sandwiched position”, for example, if the patient suddenly suffers a seizure, a respiratory failure or any other problem, or simply for temporarily allowing better access to the patient or to a specific body part of the patient, or if there is any technical failure in the medical equipment or in the patient positioning system. Using the motorized degrees of freedom patient positioning system for this purpose has the disadvantage of being slow, and this is problematic if there is a failure in the patient positioning system itself. Furthermore, if an emergency stop button is pushed when the patient is in the afore-described “sandwiched position”, then all motorized movements are principally disabled, and the patient will remain blocked in this “sandwiched position” until the system gets restarted.

To release the patient manually in such situations, most prior art patient positioning systems provide the possibility to manually actuate the drive unit of at least one motorized degree of freedom of the patient positioning system with a dedicated tool, for example a special crank lever. However, because of the very high reduction ratio in the drive unit, this manual actuation of the drive unit is very slow. For example, in some prior art patient positioning systems, more than a thousand rotations of a crank lever are required to manually release a patient. Furthermore, the operators have to be trained to be capable of efficiently using such a dedicated tool for manually releasing the patient, and the dedicated tool must be immediately at hand. Additionally, a manual actuation of the drive unit will generally require a new axis zeroing of the patient positioning system, before being able to reuse the patient positioning system in normal operation. Finally, because of the rather complicated mechanics and kinematics of the robotic wrist, it may be very complicated to act on the latter for releasing the patient out of its sandwiched therapy position

In view of the drawbacks in prior art systems, an object of the present disclosure is to provide in a device for supporting and positioning a patient in a medical equipment, a solution for manually actuating at least one of its motorized degree of freedom.

### SUMMARY

Embodiments of the present disclosure provide a device for supporting and positioning a patient in a medical equipment. This device comprises a patient support unit and a positioning mechanism supporting the patient support unit. The positioning mechanism comprises at least one motorized rotary joint member for positioning the patient support unit using a motorized pivoting motion about a pivot axis. In accordance with a first aspect of the disclosure, a rotational release unit is associated with the motorized rotary joint member. This rotational release unit comprises an override bearing and a rotation locking mechanism cooperating with the override bearing. The override bearing is arranged adjacent to or integrated in the in the rotary joint member, so as to be substantially coaxial with the pivot axis, and to allow a free pivoting motion of the positioning mechanism about the pivot axis. The rotation locking mechanism is switchable between a locked state, in which it locks the override bearing in a mechanically defined angular position, and an unlocked state, in which the override bearing is unlocked and the positioning mechanism can freely pivot about the pivot axis, i.e. an operator can manually pivot it about the pivot axis. As the axis of the override bearing is substantially coaxial to the pivot axis of the motorized rotary joint member, the operator has the impression that the motorized rotary joint member can freely rotate about its pivot axis, despite the fact that it is virtually blocked because of a high reduction ratio in its drive unit. Thus, it is possible to pivot the positioning mechanism manually out of a preset angular position, allowing, for example, a better access to the patient or to a specific body part of the patient and to pivot it, thereafter, manually back into the pre-set angular position. It will further be appreciated that a new axis zeroing of the positioning mechanism is not required.

In an exemplary embodiment of this device, the override bearing rotatably interconnects a first flange and a second flange, and the rotation locking mechanism is supported by the first flange and includes a locking member. In the locked state of the rotation locking mechanism, the locking member engages the second flange in the mechanically defined angular position, so as to warrant a form-locked transmission of a torque between the two flanges. This form-locked engagement between the locking member and the second flange in the mechanically defined angular position takes place at a radial distance D from the pivot axis, wherein this radial distance D is preferably >100 mm, or >200 mm. It will be appreciated that the greater the distance D is, the better the angular repositioning accuracy is. In the unlocked state of the rotation locking mechanism, the locking member is disengaged from the second flange, so as to allow a free relative rotation between the first flange and the second flange. This embodiment allows good repositioning accuracy after a temporary release of the patient.

The locking member may include a locking pin, which is capable of engaging a recess in the second flange in the mechanically defined angular position, so as to warrant a form-locked transmission of a torque between the two flanges. The locking pin may be a tapered locking pin received in a tapered guide hole. Such a tapered system provides an auto-centring function, which may be limited to the direction of the rotational degree of freedom to be blocked.

To reduce friction between the locking pin and the second flange, the pin may have a front surface that has the form of a spherical-dome and/or may be coated with a friction reducing material. Alternatively, the front surface of the locking pin includes a rolling ball, to achieve a rolling contact between this front surface and the second flange.

An exemplary embodiment of the rotation locking mechanism has to be powered to switch into the locked state and, if it is unpowered, switches back into the unlocked state, under the action of a passive element, for example a resilient element such as a spring. Thus, a patient may be rapidly released even if no power is available.

A detector may be mounted in the recess to detect that the locking pin is in proper engagement with the recess. Such a detector allows to detect prior to the unlocking of the release unit that such unlocking may take place, thereby providing a buffer time to take precautionary measures, such as for example cutting off the medical equipment, before the patient is released.

The switching of the rotation locking mechanism from the locked state into the unlocked state may be triggered by simultaneously pushing two release buttons, so that an operator has to use both hands to trigger this switching.

An exemplary embodiment of the rotation locking mechanism includes a linear drive for driving a locking member in a locking position. This linear drive is for example electrically, hydraulically or pneumatically powered and may include a passive element, for example a resilient element such as a spring, for urging the locking member out of the locking position, if the linear drive is unpowered.

An exemplary embodiment of the rotation locking mechanism includes a pneumatic cylinder and a control valve. The pneumatic cylinder includes a cylinder chamber, a piston, a piston rod and a return spring, the return spring retracting the piston rod into the cylinder chamber when the latter is vented. The control valve is connected to the cylinder chamber. When the control valve is powered, it connects the cylinder chamber to a pressure source. When the control valve is unpowered, it vents the cylinder chamber.

In an exemplary embodiment, the rotational release unit is arranged adjacent to the rotary joint member. If the device for supporting and positioning a patient further comprises a support base for the positioning mechanism, the rotational release unit may for example be arranged directly between the support base and the motorized rotary joint member. If the positioning mechanism comprises a support member pivotably supported by the motorized rotary joint member, or a support member pivotably supporting the motorized rotary joint member, then the rotational release unit may be arranged between the motorized rotary joint member and the support member.

In an exemplary embodiment, the rotational release unit is arranged in the rotary joint member, for example in a drive unit of the latter. For example, if the motorized rotary joint member includes an annular drive gear that is coaxial with the pivot axis, and a motor unit with a pinion meshing with the annular drive gear for motorizing the rotary joint member, the annular drive gear may be supported by the override bearing of the rotational release unit. Alternatively, the motor unit motorizing the rotary joint member may be supported by the override bearing of the rotational release unit.

If the positioning mechanism comprises two motorized rotary joint members defining two substantially vertical pivot axes, a rotational release unit as defined herein may be associated with each of the two motorized rotary joint members.

If the motorized rotary joint member has a substantially horizontal pivot axis, a damper or brake may be associated with the positioning mechanism for slowing down a gravity caused pivoting motion of the motorized rotary joint member, when the rotation locking mechanism of the rotational release unit is switched from the locked state into the unlocked state. This damper or brake may be integrated into the rotational release unit, so as to only become effective if the rotational release unit is switched from the locked state into the unlocked state.

In an exemplary embodiment, the positioning mechanism is a robotic arm, and the device further includes: an orientation mechanism with at least two motorized rotational degrees of freedom, the orientation mechanism being borne by the robotic arm and bearing the patient support unit; and an translational release unit connected between the orientation mechanism and the patient support unit. This translational release unit may include an XY translation mechanism providing two translational degrees of freedom and a translation locking mechanism cooperating with the XY translation mechanism. This translation locking mechanism is switchable between a locked state, in which it locks the two translational degrees of freedom of the XY translation mechanism in a mechanically defined position, and an unlocked state, in which the two translational degrees of freedom are unlocked. In the unlocked state, this translational release allows a rapid manual release of the patient, simply by pulling and pushing, whereas the preset orientation of the orientation mechanism is not affected. It follows that the initial position and orientation of the patient support unit may be re-established by bringing the XY translation mechanism back into its mechanically defined position.

The translation locking mechanism may provide in its locked state, a form-locked locking of the XY translation mechanism in a mechanically defined position, for example, by using a locking pin for each of said two translational degrees of freedom.

Embodiments of present disclosure provide a device for supporting and positioning a patient in a medical equipment, comprising: a patient support unit; a robotic arm supporting the patient support unit; and an orientation mechanism with at least two motorized rotational degrees of freedom, the orientation mechanism coupling the robotic arm to the patient support unit. A translational release unit is connected between the orientation mechanism and the patient support unit. This translational release unit includes: an XY translation mechanism providing two translational degrees of freedom; and a translation locking mechanism cooperating with the XY translation mechanism. The translation locking mechanism is switchable between a locked state, in which it locks the two translational degrees of freedom of the XY translation mechanism in a mechanically defined position, and an unlocked state, in which the two translational degrees of freedom are unlocked. In the unlocked state of the translation locking mechanism, the translational release unit allows to manually release the patient by simply pulling and/or pushing directly on the patient support unit. The at least two motorized rotational degrees of freedom of the orientation mechanism remain unaffected, so that the operator is exclusively confronted with a translational movement for freeing the patient. With this system, it becomes for example possible to manually push and/or pull the patient support unit temporarily in a position allowing better access to the patient or to a specific body part of the patient, and to push and/or pull it, thereafter, manually back into its therapy position, which corresponds to the mechanically defined position of the XY translation mechanism in its locked state. A new axis zeroing of the orientation mechanism is generally not required after such an operation.

Each degree of freedom is for example embodied by a linear stage, comprising a platform and a base, which are joined by a linear guide or bearing element, in such a way that the platform is restricted to guided linear motion with respect to the base.

In an exemplary embodiment, each stage comprises a separate translation locking mechanism.

In an exemplary embodiment, the translation locking mechanism comprises a locking pin providing in its locked state a form-locked locking in said mechanically defined position. The locking pin may be a tapered pin, which is capable of engaging a tapered guide hole, so as to provide, in said mechanically defined position, an auto-centering function in the direction of the translational degree of freedom to be blocked.

In an exemplary embodiment, the rotation locking mechanism has to be powered to switch into the locked state and, if it is unpowered, it switches into the unlocked state. Thus it becomes possible to release the patient even if there is no power for operating the rotation locking mechanism.

The translation locking mechanism may include a linear drive for driving a locking member in a locking position. The linear drive is electrically, hydraulically or pneumatically powered, and includes a passive element, such as a spring, for urging the locking member out of the locking position, if the linear drive is unpowered.

An exemplary embodiment of the rotation locking mechanism includes a pneumatic cylinder with a cylinder chamber, a piston, a piston rod and a return spring. The return spring retracts the piston rod into the cylinder chamber when the latter is vented. A control valve is connected to the cylinder chamber. This control valve connects the cylinder chamber to a pressure source when the control valve is powered, and vents the cylinder chamber when the control valve is unpowered.

The switching of the translation locking mechanism from the locked state into the unlocked state may be triggered by simultaneously pushing two release buttons, which may be arranged so that an operator has to use two hands to trigger this switching.

In an exemplary embodiment, the orientation mechanism includes three motorized rotational degrees of freedom, for controlling: a pitch angle, which allows a backward and forward tilting of the patient support table; a top rotation angle, which allows a planar swiveling of the patient support table; and a roll angle, which allows a side-to-side pivoting of the patient support table. In this case, the two translational degrees of freedom of the translation release unit are parallel to a plane that is perpendicular to the axis of the top rotation angle.

The XY translation mechanism may be centered on the axis of the top rotation angle, when it is in its locked state. With regard to its centered position, the XY translation mechanism provides a degree of freedom of +/−x according to the X-axis and of +/−y according to the Y axis, wherein the absolute values of x and y are both in the range of 300 mm to 800 mm.

In an exemplary embodiment, the robotic arm includes at least one motorized rotary joint member for positioning the patient support unit using a motorized pivoting motion about a pivot axis. A rotational release unit is in this case may be associated with the motorized rotary joint member. This rotational release unit comprises: an override bearing arranged adjacent to or in the in the motorized rotary joint member so as to be substantially coaxial with the pivot axis, and to allow a free pivoting motion of the positioning mechanism about the pivot axis; and a rotation locking mechanism cooperating with the override bearing, the rotation locking mechanism being switchable between a locked state, in which it locks the override bearing in a mechanically defined angular position, and an unlocked state, in which the override bearing is unlocked and the positioning mechanism can freely pivot about the pivot axis.

### BRIEF DESCRIPTION OF THE DRAWINGS

The afore-described and other features, aspects and advantages of the present disclosure will be described with hereafter with reference to the figures, wherein:

FIG. 1 is a schematic elevation view of an exemplary device for supporting and positioning a patient in a medical equipment.

FIG. 2 is a schematic section of an exemplary embodiment of a motorized rotary joint member with an associated rotational release unit.

FIG. 3 is a schematic section of an exemplary embodiment of a motorized rotary joint member with an associated rotational release unit.

FIG. 4 is a schematic section of an exemplary embodiment of a motorized rotary joint member with an associated rotational release unit.

FIG. 5 is a schematic section of an exemplary embodiment of a motorized rotary joint member with an associated rotational release unit.

FIG. 6 is perspective view of an exemplary XY-translational release unit.

FIG. 7A is a schematic diagram illustrating an exemplary locking mechanism of the release unit in a locked state.

FIG. 7B is a schematic diagram illustrating the locking mechanism of the release unit of FIG. 7A in a unlocked state.

FIG. 8 is a schematic diagram showing an exemplary locking pin and a cooperating recess of the locking mechanism of the release unit.

### DETAILED DESCRIPTION

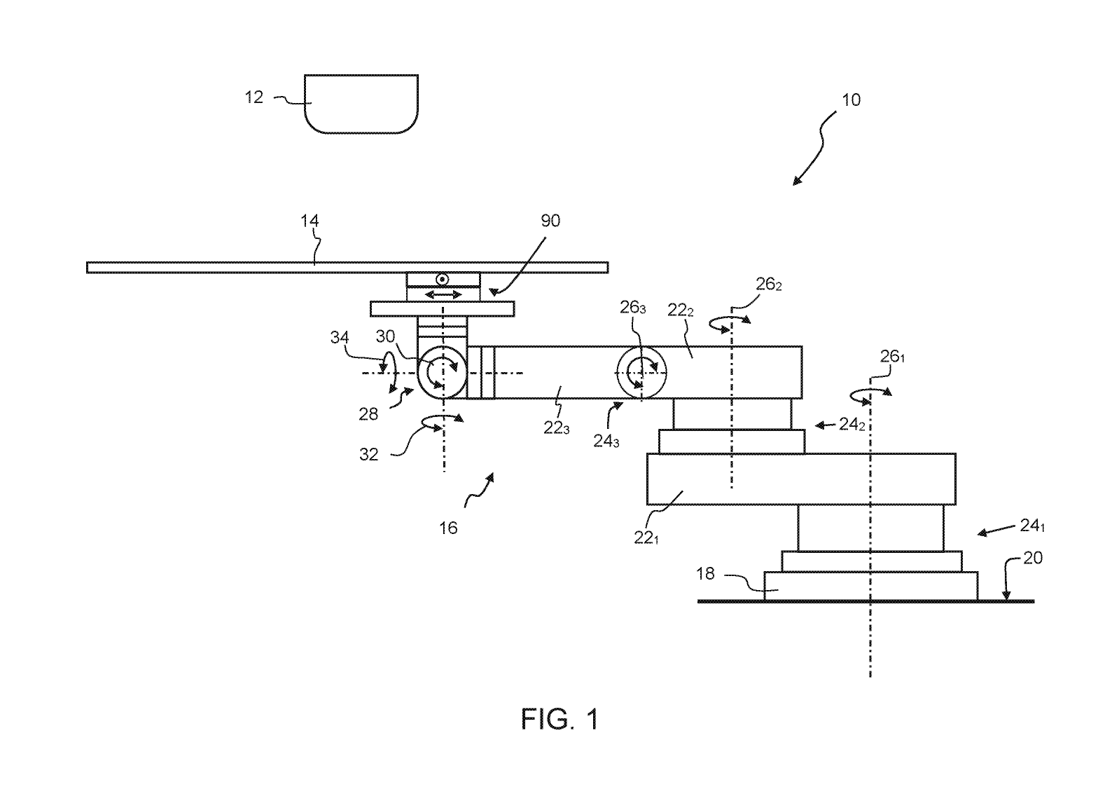

FIG. 1 schematically shows a device 10 for supporting and positioning a patient in a medical equipment, for example, a radio therapy equipment schematically represented by an irradiation nozzle 12. It will however be appreciated that the device 10 can also be used for supporting and positioning a patient in other medical equipment. In general, a device in accordance with the present disclosure provides precise motorized positioning of a patient in a treatment position and permits bringing this patient rapidly out of this treatment position.

The device 10 shown in FIG. 1 includes a patient support unit 14, which is normally a patient support table, also called a patient couch, but may also be a treatment chair or the like. In FIG. 1, this patient support table 14 is located below the irradiation nozzle 12. A patient to be irradiated (not shown) lies on the patient couch 14, sandwiched between the irradiation nozzle 12 and the patient couch 14. It will be noted that there are many situations in which it will be required to bring the patient rapidly out of this “sandwiched position”.

The patient support table 14 is supported by a positioning mechanism 16, here a robotic arm, which is itself supported by a support base 18 on a floor 20, in a pit or on any kind of external support structure. Here, the robotic arm 16 comprises three arm members 22₁, 22₂, 22₃ (generally referred to as support members). The first arm member 22₁ is connected to the support base 18 using a first motorized rotary joint member 24₁, which allows a motorized pivoting motion of the first arm member 22₁ relatively to the support base 18 and about a first pivot axis 26₁, which is substantially vertical. The second arm member 22₂ is connected to the first arm member 22₁ using a second motorized rotary joint member 24₂, which allows a motorized pivoting motion of the second arm member 22₂ relatively to the first arm member 22₁ and about a second pivot axis 26₂, which is substantially parallel to the first pivot axis 26₁ (i.e. the second pivot axis 26₂ is vertical too). The first arm member 22₁ and the second arm member 22₂ allow to adjust the horizontal X, Y coordinates of the patient support unit 14. The third arm member 22₃ is connected to the second arm member 22₂ using a third motorized rotary joint member 24₃, which allows a motorized pivoting motion of the third arm member 22₃ relative to the second arm member 22₂ and about a third pivot axis 26₃, which is substantially horizontal. This third arm member 22₃ allows a raising or lowering of the patient support unit 14, i.e. to adjust the vertical Z-coordinate of the patient support unit 14. Alternatively, the robotic arm includes for example, a vertical translational degree of freedom, for adjusting the vertical Z-coordinate of the patient support unit 14, and two rotational degrees of freedom about two parallel vertical axis, for adjusting the horizontal X, Y coordinates of the patient support unit 14.

The robotic arm 16 supports the patient support table 14 using an orientation mechanism 28, which is also called a “robotic wrist”. This orientation mechanism 28 allows to adjust the orientation of the patient support table 14 according to three rotational degrees of freedom, which are called: pitch angle 30 (allowing a back and forward tilting of the patient support table 14), top rotation angle 32 (allowing a planar swiveling of the patient support table 14), and roll angle 34 (allowing a side to side pivoting of the patient support table 14).

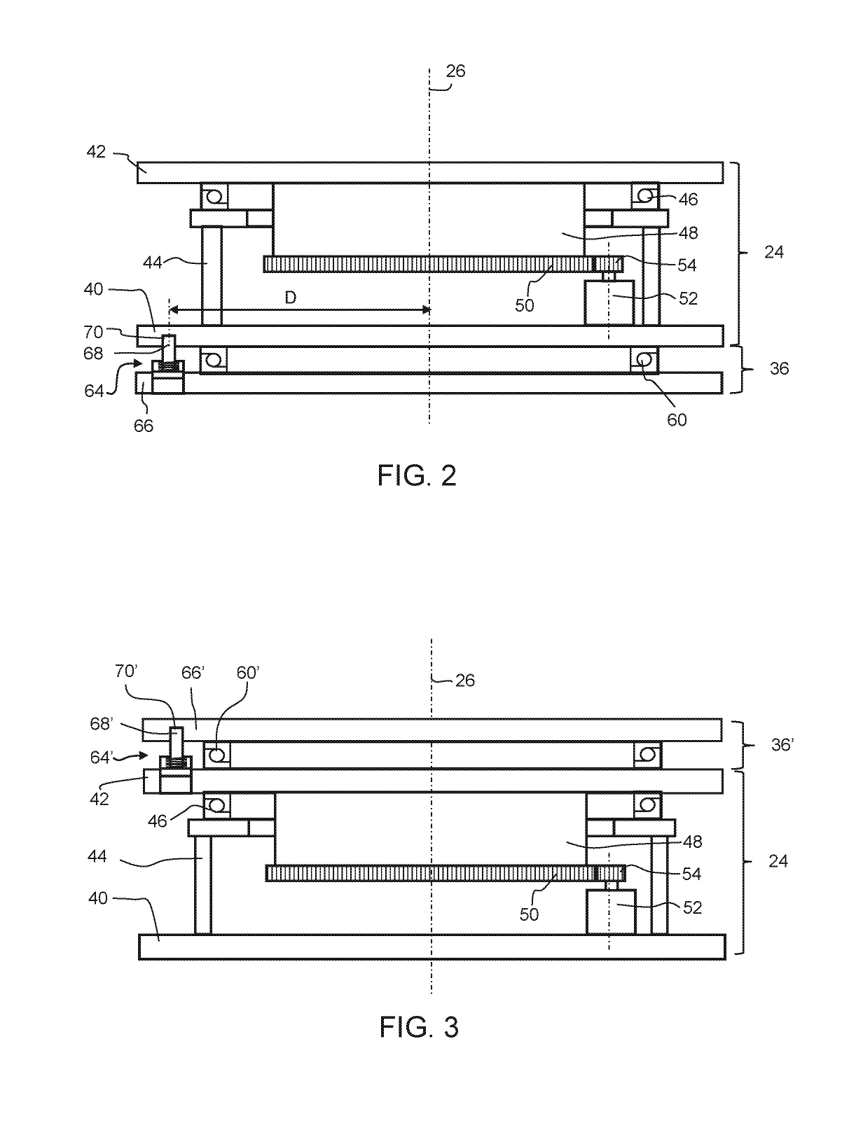

FIG. 2 schematically illustrates the mechanical layout of an exemplary embodiment of a motorized rotary joint member 24 with a rotational release unit 36. The motorized rotary joint member 24 extends between a first flange 40 and a second flange 42. The first flange 40 bears a spacing structure 44. The second flange 42 is connected to the spacing structure 44 of the first flange 40 using a joint bearing 46. The latter defines an axis of rotation forming the pivot axis 26 of the final motorized rotary joint member 24, i.e. the axis about which a motorized pivoting motion of the support member 22 connect to the second flange 42 will take place.

Reference 48 identifies a tubular drive shaft, which is supported by the second flange 42, and which supports an annular drive gear 50 coaxially with the pivot axis 26. A motor unit 52 is fixed on the first flange 40 and includes a pinion 54, which meshes with the annular drive gear 50 for pivoting the second flange 42 about the pivot axis 26. If the pivoting motion is limited to an angle of less than 360°, the annular drive gear 50 too may be an annular drive gear segment of less than 360°. The motor unit 52 generally comprises an electric motor and a gearbox designed to achieve slow motorized pivoting motion and a very precise angular positioning. As a consequence of the very high reduction ratio, which is due to the gearbox and to the large diameter annular drive gear 50 (for example, a typical diameter of this drive gear would be in the range of 300 mm to 800 mm) cooperating with the relatively small diameter pinion 54, it will be difficult to rotate by hand any arm member 22 connected to the second flange 42.

Associated with the motorized rotary joint member 24 is a rotational release unit 36. The latter mainly comprises an override bearing 60 and a rotation locking mechanism 64 cooperating with the override bearing 60. The override bearing 60 is arranged axially adjacent to the rotary joint member 24, so as to be substantially coaxial with the pivot axis 26. In FIG. 2, the override bearing 60 is connected between an auxiliary flange 66 and the first flange 40 of the motorized rotary joint member 24.

The rotation locking mechanism 64 is switchable between a locked state, in which it locks the override bearing 60 in rotation in a mechanically defined angular position, and an unlocked state, in which the override bearing 60 is unlocked, so that the first flange 40 can freely rotate relative to the auxiliary flange 66. In FIG. 2, this rotation locking mechanism 64 is supported by the auxiliary flange 66 and includes a locking pin 68. In the locked state, which is shown in FIG. 2, the locking pin 68 is engaged with a corresponding recess 70 in the first flange 40, so as to warrant a form-locked transmission of a torque between the auxiliary flange 66 and the first flange 40 in the mechanically defined angular position. In the unlocked state, the locking pin 68 is disengaged from the first flange 40, so as to allow a free relative rotation between the first flange 40 and the auxiliary flange 66. As the axis of the override bearing 60 is substantially coaxial to the axis of the joint bearing 46, the operator has the impression that the motorized rotary joint member 24 can now freely rotate about its pivot axis 26, despite the fact that it is blocked because of the afore-mentioned high reduction ratio in the drive unit 50, 52. It will be noted that the amplitude of free pivot movement is normally limited by limit stops to an angle of less than +/−180° measured from the mechanically defined angular position.

In the robotic arm 16, the auxiliary flange 66 is for example connected to the support base 18 or to an arm member 22. The second flange 42 is connected to another arm member 22. If the motor unit 52 is stopped and locked prior to switching the rotational release unit 36 into its unlocked state, the arm member 22 connected to the second flange 42 can be manually pivoted out of a specific angular position, and can thereafter be easily brought back into said specific angular position, by manually pivoting it back, until the locking pin 68 engages again with the recess 70 in the first flange 40. Thus it is possible to pivot the arm member 22 manually out of a preset angular position, for example for allowing better access to the patient or to a specific body part of the patient, and then to pivot it manually back again into the pre-set angular position with great angular accuracy. It will be noted that the angular repositioning accuracy is better, the greater the distance D between the locking pin 68 and the pivot axis 26 is. Assuming for example that this distance D is 300 mm, a play of 0.05 mm of the locking pin 68 in the recess 70 results in an angular play of less than 0.01°. The distance D will preferably be greater than 150 mm.

If the embodiment of FIG. 2 is used for the rotary joint member 24₁ in FIG. 1, the auxiliary flange 66 is connected to the support base 18, and the second flange 42 is connected to the first arm member 22₁. The rotational release unit 36 is thus arranged between the support base 18 and the motorized rotary joint member 24. If the rotation locking mechanism 64 is switched into its unlocked state, the first arm member 22₁, can be freely rotated by hand about the pivot axis 26₁.

If the embodiment of FIG. 2 is for example used for the rotary joint member 24₂ in FIG. 1, the auxiliary flange 66 may be connected to the first arm member 22₁, and the second flange 42 is connected to the second arm member 22₂. The rotational release unit 36 is thus arranged between the first arm member 22₁ and the motorized rotary joint member 24. If the rotation locking mechanism 64 is switched into its unlocked state, the second arm member 22₂, can be freely rotated by hand about the pivot axis 26₂.

FIG. 3 schematically illustrates an exemplary motorized rotary joint member 24 associated with a rotational release unit 36′, comprising an override bearing 60′ and an auxiliary flange 66′. The motorized rotary joint member 24 is identical to that of FIG. 2. Here, the override bearing 60′ now connects the auxiliary flange 66′ to the second flange 42 of the motorized rotary joint member 24. The joint bearing 46 and the override bearing 60 are located very closely together, which provides constructional advantages in many cases. As in FIG. 2, as the axis of the override bearing 60′ is substantially coaxial to the axis of the joint bearing 46′, one has the impression that—in the unlocked state of the rotational release unit 36′—the motorized rotary joint member 24 can freely rotate about its pivot axis 26, despite the fact that it is indeed blocked because of the aforementioned high reduction ratio in the drive unit. It will be noted that the embodiment of FIG. 3 also warrants a similar repositioning accuracy as the embodiment of FIG. 2.

If the embodiment of FIG. 3 is used for the rotary joint member 24₁ in FIG. 1, the auxiliary flange 66′ is connected to the second arm member 22₂, and the first flange 40 is connected to the support base 18. If it is used for the rotary joint member 24₂, the auxiliary flange 66′ is connected to the second arm member 22₂, and the first flange 40 is connected to the first arm member 22₁.

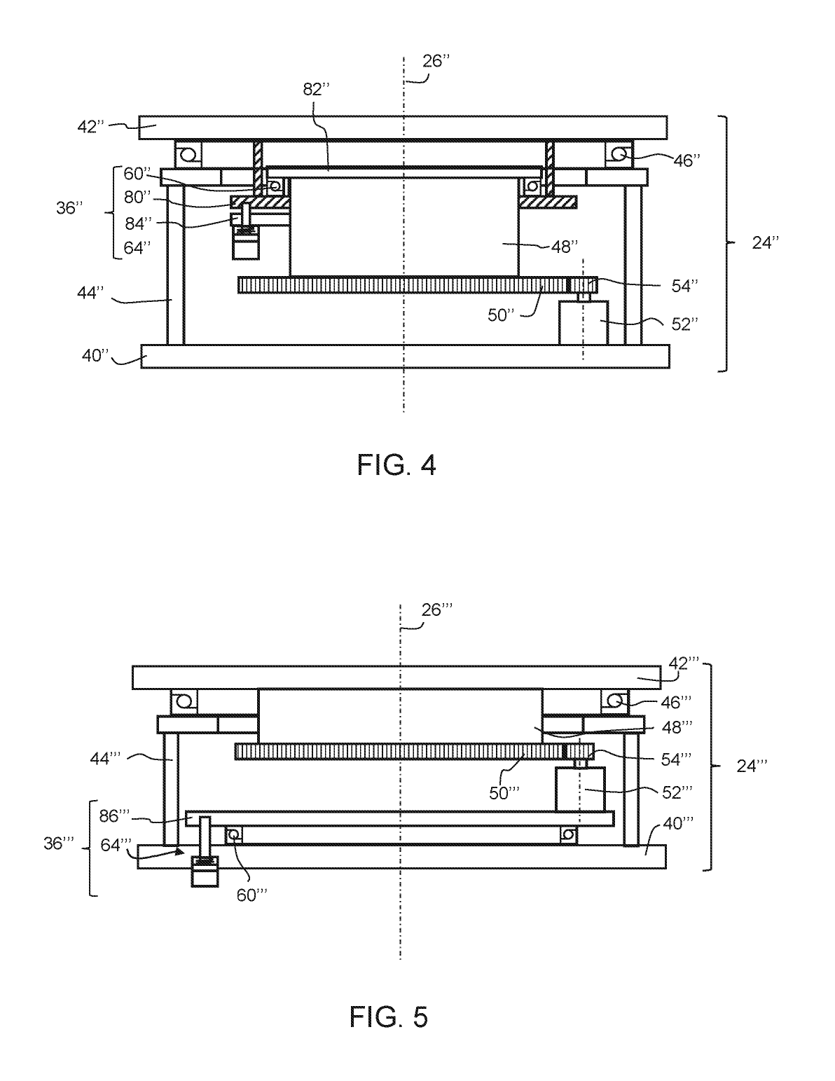

FIG. 4 shows an exemplary embodiment of a motorized rotary joint member 24″ associated with a rotational release unit 36″, which is now integrated in the motorized rotary joint member 24″. More particularly, the rotational release unit 36″ is mounted between the second flange 42″ and the annular drive gear 50″. The override bearing 60″ of the rotational release unit 36″ is for example, mounted on a flange 80″ that is fixed to the second flange 42″, so that the axis of rotation of the override bearing 60″ is coaxial to the joint bearing 46″. The tubular drive shaft 48″ bearing the annular drive gear 50″ comprises a flange 82″, by means of which it is supported by the override bearing 60″. The rotational release unit 36″ further comprises a rotation locking mechanism 64″ that is mounted for example, on a flange 84″ of the tubular drive shaft 48″ (alternatively, the rotation locking mechanism 64″ can also be mounted on the flange 80″ fixed to the second flange 42″). It follows, that if the rotation locking mechanism 64″ is in its locked state, it locks the tubular drive shaft 48″ with the annular drive gear 50″ in rotation relatively to the second flange 42″, so that the motor unit 52″ can rotate the second flange 42″ about the pivot axis 26″. If the rotation locking mechanism 64″ is switched into its unlocked state, the second flange 42″ can freely rotate about the coaxial axes of the override bearing 60″ and the joint bearing 46″, whereas the annular drive gear 50″ is blocked by the motor unit 52″.

The first flange 40″ is for example, connected to the support base 18 or to an arm member 22. The second flange 42″ is generally connected to another arm member 22. If the motor unit 52″ is stopped and locked prior to switching the rotational release unit 36″ into its unlocked state, the arm member 22 connected to the second flange 42″ can be manually pivoted about the pivot axis 26″ out of a specific angular position, and can thereafter be easily brought back into said specific angular position, by manually pivoting it back, until the locking pin engages again with the recess in the flange 80″. Consequently, after a temporary unlocking of the release unit 36″, the embodiment of FIG. 4 achieves substantially the same repositioning accuracy as the embodiments of FIGS. 2 and 3.

FIG. 5 shows an exemplary embodiment of a motorized rotary joint member 24′″ associated with a rotational release unit 36′″, which is also integrated in the motorized rotary joint member 24′″. More particularly, the rotational release unit 36′″ now includes an override bearing 60′″ that is supported on the first flange 40′″ and that supports the motor unit 52′″ via a motor support flange 86′″. It follows that, if the rotation locking mechanism 64′″ is switched into is unlocked state, the second flange 42′″ can be freely rotated, together with the annular drive gear 50′″, the motor unit 52′″ (whose pinion 54′″ is blocked in rotation) and the motor support flange 86′″. The first flange 40′″ will however remain unaffected by this manual rotation of the second flange 42′″. Also the embodiment of FIG. 5 achieves, after a temporary release, substantially the same repositioning accuracy as the embodiments of FIGS. 2 and 3.

The override bearings 60″ and 60′″ may generally be less expensive than the override bearings 60 and 60′, because the load constraints are less demanding. Indeed, whereas the override bearings 60 and 60′ have to be dimensioned essentially for the same loads as the joint bearing 46, the override bearing 60″ in FIG. 4 has to support only the tubular drive shaft 48″ with the annular drive gear 50″, and the override bearing 60′″ in FIG. 5 has to support only the motor unit 52′″. However, the embodiments of FIGS. 4 and 5 require a relatively precise alignment of the axes of rotation of the override bearing 60″, 60′″ with the joint bearing 46″, 46′″, whereas in the embodiments of FIGS. 2 and 3, there are no such precise alignment constraints for the axes of rotation of the override bearing 60, 60′ with the joint bearing 46, 46′. In the embodiments of FIGS. 2 and 3, alignment constraints for these axes of rotation are only imposed by the design of the rotary joints in the outer casing of the robotic arm 16. Consequently, in the embodiments of FIGS. 2 and 3, alignment constraints for the axes of rotation of the joint bearing and the override bearing may be reduced and even be entirely eliminated by an adequate design of the rotary joints in the outer casing of the robotic arm 16.

The joint bearings 36, 36′, 36″, 36′″ and the override bearings will normally be rolling contact bearings 60, 60′, 60″, 60′″ selected in function of the specific construction and operating conditions. It will further be understood that the mechanical structures shown in FIG. 2-5 have been simplified to better show the basic concepts underlying the present invention. In practice, the motorized rotary joint member 24, 24″, 24′″ will for example contain more than one joint bearing 46, 46″, 46′″. Furthermore, the arrangement and mounting of the bearings 46, 46″, 46′″ has to be properly designed, duly considering design loads, bearing torques, dimensions and materials, required alignment and rotation precision etc. The same applies to the rotational release units 36, 36′, 36″, 36′″ and to the override bearings 60, 60′, 60″, 60′″.

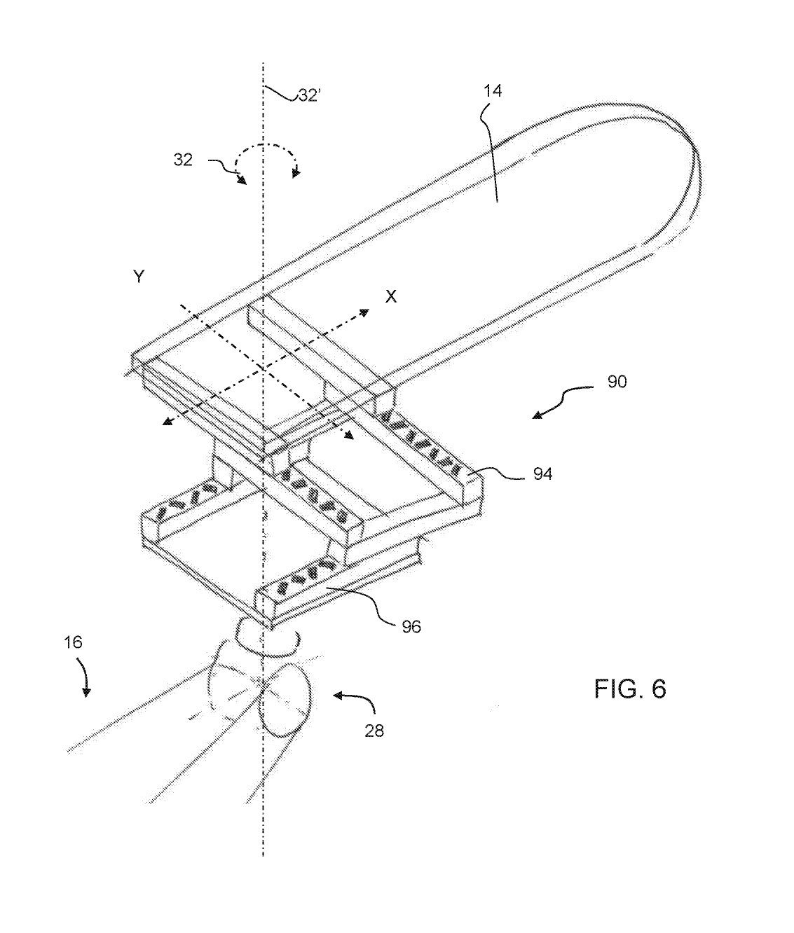

FIG. 6 shows an exemplary translational release unit 90 connected between the orientation mechanism 28 (the robotic wrist 28) and the patient support table 14. The translational release unit 90 basically comprises an XY translation mechanism providing two translational degrees of freedom. Each degree of freedom is for example embodied by a linear stage 94, 96, comprising in a known manner a platform and a base, joined by some form of guide or linear bearing, in such a way that the platform is restricted to guided linear motion with respect to the base. The platform of the linear stage 94 supports the base of the linear stage 96, and the platform of the linear stage 96 supports the patient support table 14, so as to form two translational degrees of freedom that are perpendicular to one another.

The patient support table 14 is borne by the XY translation mechanism, so that its X-axis extends parallel to the length of the patient support table 14, and its Y-axis extends parallel to the width of the patient support table 14. Both linear stages 94, 96 may be free-moving, i.e. they do not include any mechanism or motor for moving the platform relative to the base. Movement of the patient support table 14 is achieved by manually pushing or pulling the patient support table 14.

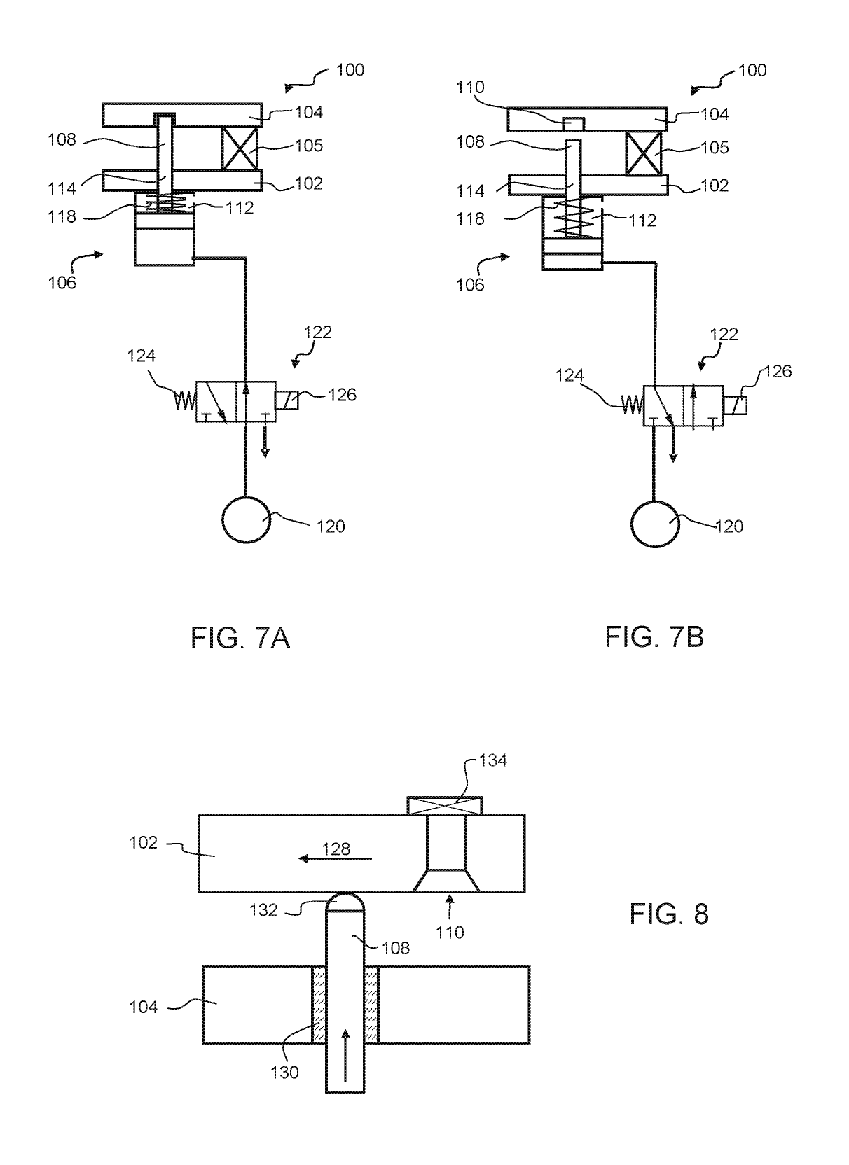

A translation locking mechanism (not seen in FIG. 6) cooperates with the XY translation mechanism, wherein it is switchable between a locked state, in which it locks the two linear stages 94, 96, and an unlocked state, in which the two linear stages 94, and 96 are unlocked (see also the description of FIGS. 7A, 7B and 8). If the two linear stages 94 and 96 are unlocked, they allow a free planar translation movement of the patient support table 14 parallel to a plane that is perpendicular to the axis 32′ of the top rotation angle 32 of the orientation mechanism. Accordingly, an operator may push or pull the patient support table 14 according to any direction perpendicular to the axis 32′ of the top rotation angle 30. When the two linear stages 94, 96 are locked, they are both centred, preferably in a form-locked manner, on the axis 32′ of the top rotation angle 32. With regard to this centred position, the XY translation mechanism provides a degree of freedom of +/−x according to the X-axis and of +/−y according to the Y-axis, wherein the absolute values of x and y are preferably in the range of 300 mm to 800 mm. Each linear stage 94, 96 may include a damper or brake for slowing down a gravity caused motion of the patient support unit, if the translation locking mechanism is switched from is locked state in its unlocked state.

FIGS. 7A and 7B are schematic diagrams further illustrating an exemplary locking mechanism 100 that may be used for a rotational release unit 36 or a translational release unit 90 as described hereinbefore. FIG. 7A shows the locking mechanism 100 in its locked status, and FIG. 7B in its unlocked status. This locking mechanism 100 is mounted between two flanges 102 and 104, which are mechanically interconnected either by a rotating bearing element, in case of a rotational release unit, or by a linear bearing element, in case of a translational release unit. In FIGS. 7A and 7B, this rotating bearing element or linear bearing element is schematically represented by a crossed box 105, which generically stands for a relative movement bearing element.

The locking mechanism 100 shown in FIGS. 7A and 7B comprises a linear actuator 106 bearing a locking pin 108. In the locked status, the locking pin 108 engages a recess 110 in the second flange 104, thereby locking the two flanges 102 and 104 in rotation or in translation, to warrant a form-locked transmission of a torque or a force between them.

The linear actuator 106 shown in FIGS. 7A and 7B may be a pneumatic cylinder, including a cylinder chamber 112, a piston rod 114 bearing the locking pin 108, and a return spring 118. The return spring 118 retracts the piston rod 114 into the cylinder chamber 112, when the latter is vented. Pressurizing the cylinder chamber 112 moves the piston rod 114 out of the cylinder chamber 112 and compresses the return spring 118. The pneumatic cylinder 106 is controlled by a control valve 122, schematically represented by a conventional graphic symbol. This control valve 122 comprises for example at least three ports and two valve positions. In the first valve position (shown in FIG. 7B), the first port is closed and the second port is internally connected to the third port. In the second valve position (shown in FIG. 7A), the first port is internally connected to the third port, and the second port is closed. A valve spring 124 urges the valve 122 into its first position, i.e. the rest position. A valve actuator 126 urges, if powered, the valve 122 into the second position. The valve actuator 126 may be connected to an uninterruptible power supply (not shown), i.e. a power supply with battery backup. When the connection between the valve actuator 126 and the uninterruptible power supply is interrupted, for example by pushing a release button (or alternatively two release buttons mounted in parallel), the valve spring 124 urges the valve 122 into its first position.

Externally, the first port of the valve 122 is connected to a pressurized air source 120, the second port is vented (i.e. connected to atmosphere) and the third port is connected to the cylinder chamber 112. Consequently, when the valve 122 is in the first position (see FIG. 7B), the cylinder chamber 112 is vented, and when the valve 122 is in the second position (see FIG. 7A), the cylinder chamber 112 is pressurized.

Instead of using such a pneumatic cylinder as actuator for the locking pin 108, one may also use a linear drive that is hydraulically or electrically powered. Furthermore, instead of using a linear actuator 106 with a locking pin 108 axially engaged into a recess 110, one may also use a pivoting mechanism that is capable of pivoting a locking member, between a locked-position, in which it engages a cooperating locking element on the second flange 104, to provide a form-locked force transmission in the direction of relative movement of the two flanges 102, 104. The pneumatic cylinder 106 (or possibly another linear drive), the axially actuated locking pin 108 and the recess 110 provide a relatively simple, cost effective and reliable solution.

With respect to the XY translation mechanism, each linear stage 94, 96 may have its own locking mechanism 100. For example, the linear actuator 106 is fixed to an element of the base (which forms the first flange 102) and the locking pin 108 engages a recess in an element of the platform (which forms the second flange 104).

As long as the linear actuator 106 is powered, the locking pin 108 remains in the recess 110, providing a form-locked coupling between the two flanges 102 and 104. If the linear actuator 106 is unpowered, the return spring 118 (or another passive element) withdraws the locking pin 108 from the recess 110, thereby opening the coupling between the two flanges 102 and 104.

To re-establish a form-locked coupling between the two flanges 102 and 104, the linear actuator 106 is powered (i.e. the pneumatic cylinder is for example pressurized) to press the locking pin 108 with a front surface 132 against the surface of the second flange 104 into which the recess 110 opens. FIG. 8 shows the locking pin 108 in this position (the linear actuator 106 itself is not shown in FIG. 8, but his action is indicated by an arrow). By manually moving the flange 104 relative to the flange 102 in the direction of the arrow 128, the recess 110 can be brought in alignment with the locking pin 108. To reduce friction between the front surface 132 of the locking pin 108 and the second flange 104, this front surface 132 may have the form of a spherical dome and/or may be coated with a friction reducing material. Alternatively, the front surface 132 of the locking pin 108 may also include a rolling ball, to achieve a rolling contact between the front surface 132 of the locking pin 108 and the second flange 104. The second flange 104 is provided with contact path having a surface quality adapted for a sliding contact, respectively a rolling contact with the front surface 132. When the locking pin 108 is aligned with the recess 110, the linear actuator 106 presses the locking pin 108 into the recess 110. To facilitate alignment of the locking pin 108 and the recess 110, the recess 110 may have a cone-shaped opening, as shown in FIG. 8.

The first flange 102 may only have to bear the linear actuator 106. It may consequently have a relatively small extension in the direction of the relative movement of the two flanges 102, 104. The second flange 104 may have to bear the recess for receiving 108 the locking pin 108 and form the (circular or linear) contact path for the front surface 132 of the locking pin 108. Its minimum extension in the direction of the relative movement of the two flanges 102, 104 is consequently determined by the length of this contact path, i.e. the extent of free relative movement the rotational release unit 36 or the translational release unit 90 shall provide.

In case of a rotational movement, the flange 104 does not have to be a planar annular flange (as shown in the drawings) or an angular segment of such a planar annular flange. It may also be a cylindrical flange or a segment of such a cylindrical flange. In case of a cylindrical flange 104, the longitudinal axis of the locking pin 108 will be perpendicular to the axis of the rotational movement. (In the embodiments shown in the drawings, the longitudinal axis of the locking pin 108 is parallel to the axis of the rotational movement).

Reference number 134 points to a detector that is mounted in the recess 110 to detect that the locking pin 108 is in proper engagement with the recess 110. This detector 134 may for example be a pressure sensitive switch that is capable of monitoring an axial contact pressure of the locking pin 108 in the recess 110. A decrease of this axial contact pressure below a pre-set pressure may then trigger an alarm and/or be incorporated a security interlocking system of the positioning device 10 and/or of the medical equipment. Monitoring the axial contact pressure of the locking pin 108 in the recess 110 allows detection, prior to the unlocking of the release unit, that such unlocking may take place.

As further seen in FIG. 8, the locking pin 108 (or the piston rod 114 shown in FIGS. 7A & 7B) may be guided (at least perpendicularly to the direction of movement that has to be locked) in a guide bushing 130 of the first flange 102, to avoid actuator 106 being subjected to forces, when the locking pin 108 transfers a torque or a force from the first flange 102 to the second flange 104.

The fit between the locking pin 108 and the recess 110 in the direction of the movement that has to be locked (i.e.: in case of a rotational movement locking, the direction tangential to the trajectory of the locking pin 108; and in case of a linear movement locking, the direction parallel to the respective X-axis or Y-axis) will strongly influence the positional accuracy of the repositioning. Consequently, whereas the fit between the locking pin 108 and the recess 110 in the direction of movement shall be relatively small (e.g. smaller than 1 mm, and preferably smaller than 0.1 mm), there may be an important clearance in the direction perpendicular to force transmission (i.e. in FIG. 8, in the direction perpendicular to the sheet). This important clearance perpendicular to force transmission makes the introduction of the locking pin 108 into the recess 110 easier.

Instead of using a cylindrical locking pin 108 (as shown in FIG. 8), it is also possible to use a tapered locking pin received in a tapered guide hole (similar to a machine tapers used for securing cutting bits and other accessories to a machine tool's spindle, as for example a so-called Morse taper system or another known taper system). Such a taper system may provide an auto-centring function, wherein it is generally preferable to limit the auto-centring function in the direction of the rotational or translational degree of freedom to be blocked.

The switching of the rotation or translation locking mechanism from the locked state into the unlocked state may take place according to the “two hands principle”, i.e. the operator has to use both hands to simultaneously push two release buttons to trigger this switching. These release buttons may be arranged close to the rotational release unit, respectively close to the translational release unit with whom they are associated. Alternatively or additionally, the device may include release buttons simultaneously releasing all motorized rotational degrees of freedom, or simultaneously releasing all motorized rotational degrees of freedom with a vertical pivot axis.

### LIST OF REFERENCE NUMERALS

| | |
|---|---|
| 10 | device for supporting and positioning a patient |
| 12 | nozzle of medical equipment |
| 14 | patient support unit |
| 16 | robotic arm (positioning mechanism) |
| 18 | support base |
| 20 | floor |
| 22 | support member (arm member); |
| 24 | motorized rotary joint member |
| 26 | pivot axis |
| 28 | orientation mechanism (robotic wrist) |
| 30 | pitch angle |
| 32 | top rotation angle |
| 34 | roll angle |
| 36 | rotational release unit |
| 40 | first flange of 24 |
| 42 | second flange of 24 |
| 44 | spacing structure |
| 46 | joint bearing |
| 48 | tubular drive shaft |
| 50 | annular drive gear |
| 52 | motor unit |
| 54 | pinion |
| 60 | override bearing |
| 64 | rotation locking mechanism |
| 66 | auxiliary flange |
| 68 | locking member or pin |
| 70 | recess |
| 80″ | flange of 36″ |
| 82″ | flange of 36″ |
| 84″ | flange of 36″ |
| 90 | translational release unit |
| 94 | linear stage (X-axis) |
| 96 | linear stage (Y-axis) |
| 100 | locking element |
| 102 | first flange of 100 |
| 104 | second flange of 100 |
| 105 | relative movement bearing e |
| 106 | linear actuator/pneumatic cylinder |
| 108 | locking pin |
| 110 | recess |
| 112 | cylinder chamber |
| 114 | piston rod |
| 118 | spring |
| 122 | control valve |
| 120 | pressurized air source |
| 124 | valve spring |
| 126 | valve actuator |
| 128 | arrow, indicating the direction of movement |
| 130 | guide bushing |
| 132 | front surface of 108 |
| 134 | detector |

1-15. (canceled)

16. A device for supporting and positioning a patient in a medical equipment, comprising:
a patient support unit; and
a positioning mechanism supporting the patient support unit, wherein the positioning mechanism including:
a motorized rotary joint member for positioning the patient support unit using a motorized pivoting motion about a pivot axis; and
a rotational release unit associated with the motorized rotary joint member, wherein the rotational release unit includes:
an override bearing arranged adjacent to the motorized rotary joint member, wherein the override bearing is configured to be substantially coaxial with the pivot axis and allow a free pivoting motion of the positioning mechanism about the pivot axis; and
a rotation locking mechanism cooperating with the override bearing, wherein the rotation locking mechanism switches between a locked state and an unlocked state, wherein:
in the locked state, the rotation locking mechanism locks the override bearing in a mechanically defined angular position, and
in the unlocked state, the override bearing is unlocked and the positioning mechanism is configured to freely pivot about the pivot axis.

17. The device of claim 16, wherein:
the override bearing rotatably interconnects a first flange and a second flange;
the rotation locking mechanism is supported by the first flange and includes a locking member, wherein:
in the locked state, the locking member engages the second flange and provides a form-locked transmission of a torque between the first flange and the second flange; and
in the unlocked state, the locking member disengages from the second flange to enable relative rotation between the first flange and the second flange.

18. The device of claim 17, wherein:
the locking member is a locking pin configured to engage a recess in the second flange.

19. The device of claim 18, wherein:
the locking pin is a tapered locking pin configured to engage a tapered guide hole in the second flange, and provide an auto-centering function in the direction of the rotational degree of freedom to be blocked.

20. The device of claim 16, wherein:
the rotation locking mechanism includes a linear drive for driving a locking member in a locking position, the linear drive being electrically, hydraulically or pneumatically powered; and
the linear drive includes a passive element for urging the locking member out of the locking position, when the linear drive is unpowered.

21. The device of claim 20, wherein the passive element is a spring.

22. The device of claim 16, wherein:
the rotation locking mechanism is powered to switch into the locked state; and
wherein the rotation locking mechanism switches to the unlocked state when unpowered.

23. The device of claim 16, wherein the rotation locking mechanism further comprises:
a pneumatic cylinder including a cylinder chamber, a piston, a piston rod and a return spring, wherein the return spring retracts the piston rod into the cylinder chamber when the cylinder chamber is vented; and
a control valve, wherein the control valve:
connects the cylinder chamber to a pressure source when the control valve is powered; and
vents the cylinder chamber when the control valve is unpowered.

24. The device of claim 16, further comprising a support base for the positioning mechanism, wherein:
the rotational release unit is arranged between the support base and the motorized rotary joint member.

25. The device of claim 16, wherein:
the positioning mechanism comprises a support member pivotably supported by the motorized rotary joint member; and
the rotational release unit is arranged between the motorized rotary joint member and the support member.

26. The device of claim 16, wherein:
the positioning mechanism comprises a support member pivotably supporting the motorized rotary joint member; and
the rotational release unit is arranged between the motorized rotary joint member and the support member.

27. The device of claim 16, wherein:
the motorized rotary joint member comprises:
an annular drive gear configured to be coaxial with the pivot axis; and
a motor unit including a pinion for engaging with the annular drive gear to motorize the rotary joint member;
wherein the annular drive gear is supported by the override bearing of the rotational release unit.

28. The device of claim 16, wherein:
the motorized rotary joint member includes a motor unit supported by the override bearing of the rotational release unit.

29. The device of claim 16, wherein:
the positioning mechanism comprises at least two motorized rotary joint members defining two substantially vertical pivot axes, wherein each of the at least two motorized rotary joint members includes the rotational release unit.

30. The device of claim 16, wherein:
the motorized rotary joint member has a substantially horizontal pivot axis; and
the rotational release unit further includes a brake element for slowing down a pivoting motion about the substantially horizontal pivot axis when the rotation locking mechanism switches from the locked state to the unlocked state.

31. The device of claim 16, wherein the override bearing is arranged in the motorized rotary joint member.

32. The device of claim 16, wherein the positioning mechanism is a robotic arm and the device further comprises:
a robotic wrist including at least two motorized rotational degrees of freedom, the robotic wrist coupling the robotic arm to the patient support unit; and
a translational release unit connected between the robotic wrist and the patient support unit, the translational release unit including:
an XY translation mechanism providing two translational degrees of freedom; and
a translation locking mechanism cooperating with the XY translation mechanism, wherein the translation locking mechanism switches between a locked state and an unlocked state, wherein:
in the locked state, the translation locking mechanism locks the two translational degrees of freedom of the XY translation mechanism in a mechanically defined position; and
in the unlocked state, the two translational degrees of freedom are unlocked.

33. The device of claim 32, wherein:
the XY translation mechanism includes a first linear stage and a second linear stage for providing the two translational degrees of freedom, wherein each linear stage further includes:
a platform;
a base; and
a linear guide, wherein the linear guide couples the platform to the base to enable the platform to move in a guided linear motion with respect to the base.

34. The device of claim 32, wherein:
the translation locking mechanism further comprises:
a first translation locking mechanism cooperating with the first linear stage to enable switching between the locked state and the unlocked state; and
a second translation locking mechanism cooperating with the second linear stage to enable switching between the locked state and the unlocked state.

35. The device as claimed in claim 32, wherein:
the translation locking mechanism includes a locking pin providing a form-locked locking of the XY translation mechanism in the mechanically defined position when in the locked state.

36. The device of claim 35, wherein:
the locking pin is a tapered pin configured to engage a tapered guide hole to provide an auto-centering function in the direction of the translational degree of freedom to be blocked.

37. The device of claim 32, wherein:
the translation locking mechanism includes a linear drive for driving a locking member in a locking position, the linear drive being electrically, hydraulically or pneumatically powered; and
the linear drive includes a passive element for urging the locking member out of the locking position, when the linear drive is unpowered.

38. The device of claim 32, wherein:
the translation locking mechanism is powered to switch into the locked state; and
wherein the translation locking mechanism switches to the unlocked state when unpowered.

39. The device of claim 32, wherein the translation locking mechanism further comprises:
a pneumatic cylinder including a cylinder chamber, a piston, a piston rod and a return spring, wherein the return spring retracts the piston rod into the cylinder chamber when the cylinder chamber is vented; and
a control valve, wherein the control valve connects the cylinder chamber to a pressure source when the control valve is powered, and vents the cylinder chamber when the control valve is unpowered.

40. The device of claim 32, wherein:
the translation locking mechanism switches from the locked state to the unlocked state by simultaneously pushing two release buttons, wherein the two release buttons are arranged to require an operator to use both hands to simultaneously push the two release buttons.

41. The device of claim 32, wherein:
the robotic wrist is configured to provide three motorized rotational degrees of freedom for controlling:
a pitch angle, to enable tilting of the patient support table;
a top rotation angle, to enable a planar swiveling of the patient support table, and
a roll angle, to enable side-to-side pivoting of the patient support table; and
wherein the two translational degrees of freedom are parallel to a plane that is perpendicular to the axis of the top rotation angle.

42. The device of claim 41, wherein:
in the locked state, the XY translation mechanism is centered on the axis of the top rotation angle.

43. The device of claim 42, wherein:
the XY translation mechanism provides a degree of freedom of +/−x with respect to the X-axis, and a degree of freedom of +/−y with respect to the Y-axis, wherein the absolute values of x and y are in the range of 300 mm to 800 mm.

44. A method for supporting and positioning a patient in a medical equipment, the method comprising:
positioning a patient support unit using a motorized rotary joint member that provides a motorized pivoting motion about a pivot axis;
enabling, using an override bearing arranged adjacent to the motorized rotary joint member, a free pivoting motion of a positioning mechanism about the pivot axis, wherein the override bearing is configured to be substantially coaxial with the pivot axis;
switching a rotation locking mechanism between a locked state and an unlocked state, wherein the rotation locking mechanism cooperates with the override bearing;
locking, using the rotation locking mechanism, the override bearing in a mechanically defined angular position during the locked state; and
unlocking the override bearing during the unlocked state to enable the positioning mechanism to freely pivot about the pivot axis.

45. The method of claim 44, further comprising:
providing, using an XY translation mechanism, two translational degrees of freedom;
switching a translation locking mechanism between a locked state and an unlocked state, wherein the translation locking mechanism cooperates with the XY translation mechanism;
locking, using the translation locking mechanism, the two translational degrees of freedom of the XY translation mechanism in a mechanically defined position during the locked state; and
unlocking the two translational degrees of freedom in the unlocked state.

46. A patient positioning system, comprising:
a patient support unit; and
a positioning mechanism supporting the patient support unit, wherein the positioning mechanism includes:
a motorized rotary joint member for positioning the patient support unit using a motorized pivoting motion about a pivot axis; and
a rotational release unit associated with the motorized rotary joint member, wherein the rotational release unit includes:
an override bearing arranged adjacent to the motorized rotary joint member, wherein the override bearing is configured to be substantially coaxial with the pivot axis and allow a free pivoting motion of the positioning mechanism about the pivot axis; and
a rotation locking mechanism cooperating with the override bearing, wherein the rotation locking mechanism switches between a locked state and an unlocked state, wherein:
in the locked state, the rotation locking mechanism locks the override bearing in a mechanically defined angular position, and
in the unlocked state, the override bearing is unlocked and the positioning mechanism is configured to freely pivot about the pivot axis.

47. The system of claim 46, wherein the positioning mechanism is a robotic arm and the system further comprises:
a robotic wrist including at least two motorized rotational degrees of freedom, the robotic wrist coupling the robotic arm to the patient support unit; and
a translational release unit connected between the robotic wrist and the patient support unit, the translational release unit including:
an XY translation mechanism providing two translational degrees of freedom; and
a translation locking mechanism cooperating with the XY translation mechanism, wherein the translation locking mechanism switches between a locked state and an unlocked state, wherein:
in the locked state, the translation locking mechanism locks the two translational degrees of freedom of the XY translation mechanism in a mechanically defined position; and
in the unlocked state, the two translational degrees of freedom are unlocked.
